(19) United States
(12) Patent Application Publication
(10) Pub. No.: US 2015/0378541 A1
(43) Pub. Date: Dec. 31, 2015

(54) METHOD AND DEVICE FOR ASSISTING USE OF CARD

(71) Applicant: Samsung Electronics Co., Ltd., Suwon-si (KR)

(72) Inventors: Suck-Ho SEO, Suwon-si (KR); Dong-Hyoun SON, Suwon-si (KR); Ji-Ryang CHUNG, Suwon-si (KR)

(21) Appl. No.: 14/748,828

(22) Filed: Jun. 24, 2015

(30) Foreign Application Priority Data
Jun. 26, 2014 (KR) 10-2014-0079072

(51) Int. Cl. G06F 3/0484; G09G 5/12; G09G 5/36

(52) U.S. Cl. CPC G06F 3/0484; G09G 5/363; G09G 5/12; G09G 2370/22; G09G 2354/00

(57) ABSTRACT

A method and a device for displaying a User Interface (UI) screen in an electronic device are provided. The electronic device detects detachment of the card from a cover operatively connected to the electronic device and displays a UI screen related to use of the card in response to detecting the detachment of the card.

### CROSS-REFERENCE TO RELATED APPLICATION(S)

This application claims the benefit under 35 U.S.C. §119(a) of a Korean patent application filed on Jun. 26, 2014 in the Korean Intellectual Property Office and assigned Serial number 10-2014-0079072, the entire disclosure of which is hereby incorporated by reference.

### TECHNICAL FIELD

The present disclosure relates to a method and device for displaying a User Interface (UI) screen on an electronic device.

### BACKGROUND

A cover for an electronic device, such as a smartphone, may be used to prevent the electronic device from being damaged by an external shock or scratch. Among various forms of covers, a cover including a card receiving portion capable of receiving a card may be used. A user of the electronic device may keep various types of cards such as a payment card like a credit card or a debit card and a membership card in the cover of the electronic device.

When pulling out the card from the cover of the electronic device to use the card, the user may use an application related to the use of the card among applications of the electronic device. For example, upon using the card, the user may read a card use notification message received in the electronic device by using a message application. In another example, the user may see a list of discount coupons stored in the electronic device displayed using a coupon list application and the user may use a desired coupon.

The above information is presented as background information only to assist with an understanding of the present disclosure. No determination has been made, and no assertion is made, as to whether any of the above might be applicable as prior art with regard to the present disclosure.

### SUMMARY

Until the user launches an application related to the use of a card by manipulating the electronic device to display a User Interface (UI) screen necessary for the use of the card, the user needs to undergo several stages. For example, the user needs to turn on and unlock the screen, and then launch the application necessary for the use of the card to display a necessary UI screen.

Aspects of the present disclosure are to address at least the above-mentioned problems and/or disadvantages and to provide at least the advantages described below. Accordingly, an aspect of the present disclosure is to provide a method and device for assisting the use of a card, in which when a user takes out a card kept in a cover of an electronic device, a UI screen related to the use of the card is automatically displayed.

In accordance with an aspect of the present disclosure, a method for assisting use of a card in an electronic device is provided. The method includes detecting detachment of the card from a cover operatively connected to the electronic device, and in response to detecting the detachment of the card, displaying a UI screen related to use of the card.

In accordance with another aspect of the present disclosure, an electronic device is provided. The electronic device includes a display configured to display a UI screen related to use of a card, and a controller configured to detect detachment of the card from a cover operatively connected to the electronic device, and to display a UI screen related to use of the card through the display in response to detecting detachment of the card from the cover.

In accordance with another aspect of the present disclosure, a computer-readable recording medium having recorded thereon a program to be executed on a computer, in which the program includes executable instructions that, when executed by a processor, cause the processor to perform operations of detecting detachment of the card from a cover operatively connected to the electronic device, and in response to detecting the detachment of the card, displaying a UI screen related to use of the card is provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network environment including an electronic device according to various embodiments of the present disclosure;

FIGS. 2 and 3 are diagrams illustrating a state in which a cover having a card attachment/detachment sensor installed therein is coupled to an electronic device according to various embodiments of the present disclosure;

FIGS. 4A, 4B, and 4C are diagrams for describing card attachment/detachment detecting according to various embodiments of the present disclosure;

FIG. 5 is a flowchart illustrating operations of an electronic device according to various embodiments of the present disclosure;

FIG. 6 is a diagram illustrating a User Interface (UI) screen according to various embodiments of the present disclosure;

FIG. 7 is a flowchart illustrating operations of displaying a UI screen by an electronic device according to various embodiments of the present disclosure;

FIGS. 8, 9, 10, 11, 12, and 13 are flowcharts illustrating operations of determining a UI screen to be displayed by an electronic device according to various embodiments of the present disclosure;

FIG. 14 is a flowchart illustrating operations of an electronic device according to various embodiments of the present disclosure; and

FIG. 15 is a block diagram illustrating an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms “include” or “may include” used in various embodiments of the present disclosure indicate an existence of disclosed function, operation, or element, but do not limit an existence of one or more other functions, operations, or elements. Terms “include” or “has” used in the present disclosure should be understood that they are intended to indicate an existence of feature, number, step, operation, element, component or any combination thereof, disclosed in the specification, but should not be understood that they are intended to previously exclude an existence of one or more other features, numbers, steps, operations, elements, component, or any combination thereof or possibility of adding those things.

The term “or” in various embodiments of the present disclosure includes any or every combination of listed terms. For example, “A or B” may include either A or B, or both A and B.

Although ordinal numbers such as “first”, “second”, and so forth will be used to describe various elements, those elements are not limited by the terms. For example, the terms do not limit the order and/or importance of the elements. The terms are used for distinguishing one element from another element. For example, a first user device and a second user device are both user devices, and indicate different user devices. In addition, a first element may be referred to as a second element and likewise, a second element may also be referred to as a first element, without departing from the teaching of the present disclosure.

When it is said that an element is “connected” or “coupled” with another element, it should be understood that the element may be directly connected with another element, or still another element may exist between the elements. In contrast, when an element is said to be “directly connected” or “directly coupled” with another element, one should understand that no component exists between the elements.

Terms used in various embodiments of the present disclosure are intended to describe an embodiment, rather than to limit the various embodiments of the present disclosure. As used herein, the singular forms are intended to include the plural forms as well, unless the context clearly indicates otherwise.

Unless otherwise defined, all terms (including technical and scientific terms) used herein have the same meaning as commonly understood by one of ordinary skill in the art to which various embodiments belong. One will understand that terms, such as those defined in commonly used dictionaries, should be interpreted as having a meaning that is consistent with their meaning in the specification with the context of the relevant art as understood by the artisan at the time of disclosure and will not be interpreted in an idealized or overly formal sense unless expressly so defined herein.

The phrase ‘a state in which a card has been previously detached’ used in various embodiments of the present disclosure may mean that prior to current detachment of the card, the card has been previously detached.

An electronic device according to various embodiments of the present disclosure may include, for example, at least one of a smartphone, a tablet Personal Computer (PC), a mobile phone, a video phone, an electronic(e)-book reader, a laptop PC, a netbook computer, a Personal Digital Assistant (PDA), a Portable Multimedia Player (PMP), an MPEG-1 audio layer-3 (MP3) player, mobile medical equipment, a camera, and a wearable device (e.g., a Head-Mounted-Device (HMD), an electronic clothing, an electronic bracelet, an electronic necklace, an electronic appcessory, an electronic tattoo, or a smart watch).

According to some embodiments of the present disclosure, an electronic device may be a smart home appliance, for example, at least one of a television (TV), a Digital Video Disk (DVD) player, an audio player, a game console, an electronic dictionary, an electronic key, a camcorder, and an electronic frame.

According to various embodiments of the present disclosure, an electronic device may be a combination of one or more of the aforementioned various devices. An electronic device according to various embodiments of the present disclosure may be a flexible device. It is obvious to those of ordinary skill in the art that an electronic device according to various embodiments of the present disclosure is not limited to the aforementioned devices.

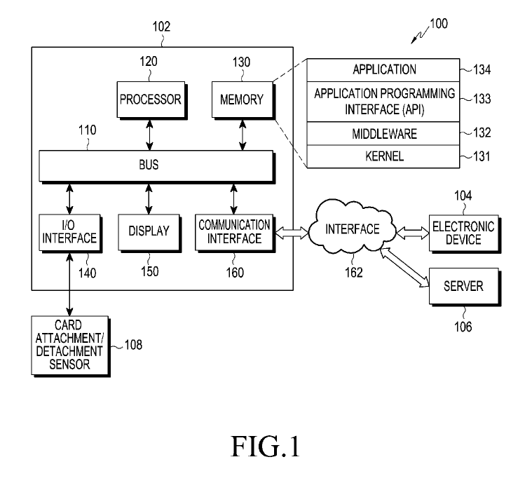

FIG. 1 is a block diagram illustrating a network environment including an electronic device according to various embodiments of the present disclosure.

Referring to FIG. 1, a network environment 100 including an electronic device 102 is provided. As illustrated in FIG. 1, the electronic device 102 may include a bus 110, a processor 120, a memory 130, an input/output interface 140, a display 150, and a communication interface 160. The bus 110 may be a circuit that connects the foregoing elements of the electronic device 102 with each other and delivers communication (e.g., a control message) between the elements.

The processor 120 may receive a command from the above-described other elements (e.g., the memory 130, the input/output interface 140, the display 150, and the communication interface 160) through the bus 110, decode the received command, and execute an operation or data processing corresponding to the decoded command.

The memory 130 may store a command or data received from or generated by the processor 120 or other elements (e.g., the input/output interface 140, the display 150, and the communication interface 160). The memory 130 may include programming modules, for example, a kernel 131, a middleware 132, an Application Programming Interface (API) 133, one or more applications 134, and the like. These programming modules may include software, firmware, hardware, or any combination thereof.

The kernel 131 may control or manage system resources (e.g., the bus 110, the processor 120, and the memory 130) used to execute an operation or a function implemented in the other programming modules, for example, the middleware 132, the API 133, and the applications 134. The kernel 131 may provide an interface through which the middleware 132, the API 133, or the applications 134 accesses a separate element of the electronic device 102 to control or manage the separate element.

The middleware 132 may perform a relay operation such that the API 133 or the applications 134 exchanges data in communication with the kernel 131. The middleware 132 may perform control (e.g., scheduling or load balancing) among task requests received from the applications 134, by using a method of assigning a priority for using a system resource (e.g., the bus 110, the processor 120, or the memory 130) of the electronic device 102 to, for example, at least one of the applications 134.

The API 133 may be an interface through which the applications 134 control a function provided by the kernel 133 or the middleware 132, and may include at least one interface or function (e.g., a command) for, for example, file control, window control, image processing or character control.

According to various embodiments of the present disclosure, the applications 134 may include a Short Messaging Service (SMS)/Multimedia Messaging Service (MMS) application, an e-mail application, a calendar application, an alarm application, a health care application (e.g., an application for measuring the amount of exercise, a blood sugar level, a heart rate, or the like), an environment information application (e.g., an application for providing air pressure, humidity, or temperature information), and the like. Additionally or alternatively, the applications 134 may include an application related to information exchange between the electronic device 102 and an external electronic device (e.g., an electronic device 104). The application associated with information exchange may include, for example, a notification relay application for relaying particular information to the external electronic device or a device management application for managing the external electronic device.

For example, the notification relay application may include a function of relaying notification information generated in another application (e.g., an SMS/MMS application, an e-mail application, a health care application, or an environment information application) of the electronic device 102 to the external electronic device (e.g., the electronic device 104). Additionally or alternatively, the notification relay application may, for example, receive notification information from the external electronic device (e.g., the electronic device 104) and provide the notification information to a user. The device management application may manage (e.g., install, remove, or update) a function of at least a part of the external electronic device (e.g., the electronic device 104) communicating with the electronic device 102 (e.g., activation/deactivation of the external electronic device (or an element thereof) or adjustment of a brightness (or a resolution) of a display), an application running on the external electronic device, or a service (e.g., a call service or a message service) provided on the external electronic device.

According to various embodiments of the present disclosure, the applications 134 may include an application designated according to a property (e.g., a type of an electronic device) of the external electronic device (e.g., the electronic device 104). For example, if the external electronic device is an MP3 player, the applications 134 may include an application related to music playback. Likewise, if the external electronic device is a mobile medical device, the applications 134 may include an application related to health care. According to various embodiments of the present disclosure, the applications 134 may include at least one of an application designated in the electronic device 102 and an application received from the external electronic device (e.g., the server 106 or the electronic device 104).

The input/output interface 140 may deliver a command or data, which is input from a user through an input/output device (e.g., a sensor, a keyboard, or a touch screen), for example, to the processor 120, the memory 130, and the communication interface 160 through the bus 110. For example, the input/output interface 140 may output a command or data received from the processor 120, the memory 130, and the communication interface 160 through the bus 110, to an input/output device (e.g., a speaker or a display).

The display 150 may display information (e.g., multimedia data or text data) to the user. According to various embodiments of the present disclosure, the display 150 may display a User Interface (UI) screen related to the use of a card.

The communication interface 160 may connect communication between the electronic device 102 and the external device (e.g., the electronic device 104 or the server 106). For example, the communication interface 160 may be connected to a network 162 through wireless communication or wired communication for communication with the external device. Wireless communication may include at least one of WiFi, Bluetooth (BT), Near Field Communication (NFC), a Global Positioning System (GPS), and cellular communication (e.g., Long Term Evolution (LTE), LTE-Advanced (LTE-A), Code Division Multiple Access (CDMA), Wideband CDMA (WCDMA), a Universal Mobile Telecommunication System (UMTS), Wireless Broadband (WiBro), a Global System for Mobile Communications (GSM), and so forth). Wired communication may include at least one of Universal Serial Bus (USB), a High-Definition Multimedia Interface (HDMI), Recommended Standard (RS)-232, and a Plain Old Telephone Service (POTS).

According to various embodiments of the present disclosure, the network 162 may be a telecommunications network. The telecommunications network may include at least one of a computer network, Internet, Internet of things, and a telephone network. According to various embodiments of the present disclosure, a protocol for communication between the electronic device 102 and the external device (e.g., a transport layer protocol, a data link layer protocol, or a physical layer protocol) may be supported in at least one of the applications 134, the API 133, the middleware 132, the kernel 131, and the communication interface 160.

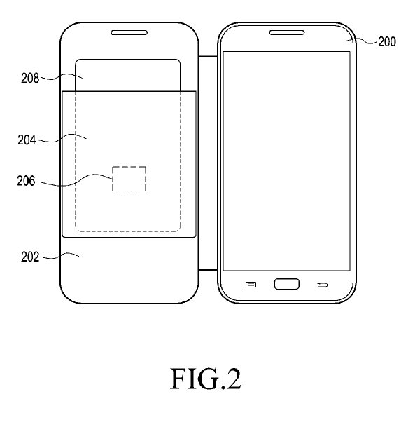

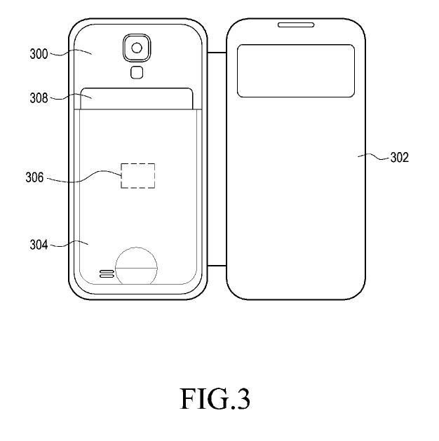

According to various embodiments of the present disclosure, a card attachment/detachment sensor 108 may be connected to the electronic device 102. The card attachment/detachment sensor 108 may be installed in a card receiving portion (not illustrated) included in a cover (not illustrated) used by being coupled to the electronic device 102, as in an example illustrated in FIGS. 2 and 3. The card attachment/detachment sensor 108 may detect attachment/detachment of a card to/from the card receiving portion and provides a detecting result to the electronic device 102.

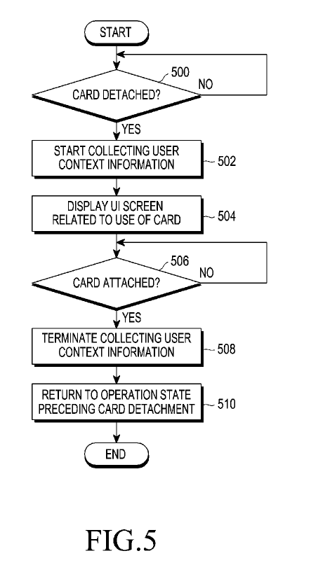

According to various embodiments of the present disclosure, a controller may include a processor 120 and a memory 130 for storing information requested by the processor 120. The controller may be a Central Processing Unit (CPU). The controller may control overall operation of the electronic device 102, and perform operations corresponding to a method for assisting the use of a card according to various embodiments of the present disclosure. According to various embodiments of the present disclosure, upon detecting card detachment from the cover, the controller may display a UI screen related to the use of the card on the display 150. The operations of the controller corresponding to the method for assisting the use of the card will be described later with reference to FIGS. 5 through 14.

FIGS. 2 and 3 are diagrams illustrating a state in which a cover having a card attachment/detachment sensor installed therein is coupled to an electronic device according to various embodiments of the present disclosure.

Referring to FIG. 2, a cover 202 of an electronic device 200 may include a card receiving portion 204 and a card attachment/detachment sensor 206. The electronic device 200 may correspond to the electronic device 102 illustrated in FIG. 1, and the card attachment/detachment sensor 206 may correspond to the card attachment/detachment sensor 108 illustrated in FIG. 1. In FIG. 2, the card receiving portion 204 and the card attachment/detachment sensor 206 may be provided in an inner side of a front cover of the cover 202, which covers a front surface of the electronic device 200.

The card receiving portion 204 may receive a card 208. The card attachment/detachment sensor 206 may be installed in the card receiving portion 204. The card attachment/detachment sensor 206 may detect attachment/detachment (e.g., the insertion or the removal) of the card 208 to/from the card receiving portion 204 and provide a detection result to the electronic device 200.

Referring to FIG. 3, a cover 302 of an electronic device 300 may include a card receiving portion 304 and a card attachment/detachment sensor 306. The electronic device 300 may correspond to the electronic device 102 illustrated in FIG. 2, and the card attachment/detachment sensor 306 may correspond to the card attachment/detachment sensor 108 illustrated in FIG. 1. In FIG. 3, the card receiving portion 304 and the card attachment/detachment sensor 306 may be provided in an outer side of a rear cover of the cover 302, which covers a rear surface of the electronic device 300.

The card receiving portion 304 may receive a card 308. The card attachment/detachment sensor 306 may be installed in the card receiving portion 304. The card attachment/detachment sensor 306 may detect attachment/detachment (e.g., the insertion or the removal) of the card 308 to/from the card receiving portion 304 and provide a detection result to the electronic device 300.

According to various embodiments of the present disclosure, the card attachment/detachment sensor 108 may be connected to the input/output interface 140 of the electronic device 102 in a wired manner. According to various embodiments of the present disclosure, the card attachment/detachment sensor 108 may be connected to the communication interface 160 of the electronic device 102 through wireless communication such as NFC or BT. If the card attachment/detachment sensor 108 is connected to the communication interface 160 through wireless communication, the cover 302 may include a wireless communication module such as an NFC module or a BT module for wireless communication.

According to various embodiments of the present disclosure, attachment/detachment (e.g., the insertion or the removal) of a card such as an Integrated Circuit (IC) card may be detected through an NFC module that may be included in the communication interface 160. In this case, the cover may not include the card attachment/detachment sensor 108.

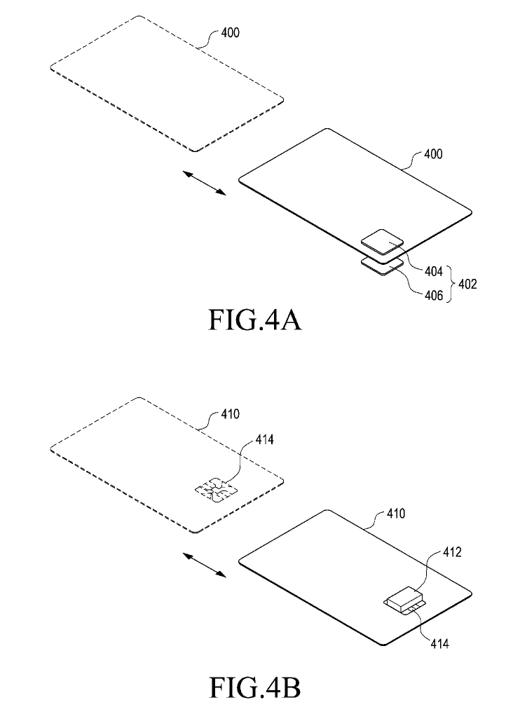

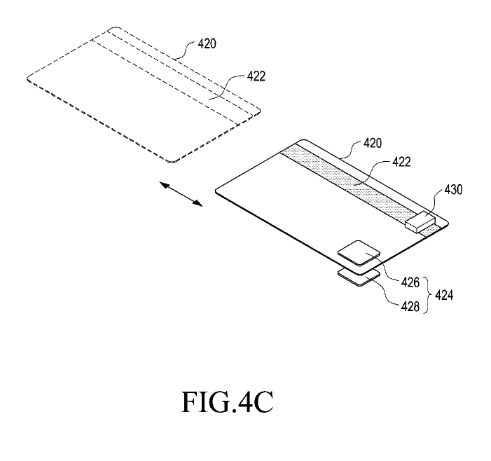

FIGS. 4A to 4C are diagrams for describing card attachment/detachment detecting according to various embodiments of the present disclosure.

FIG. 4A illustrates an example in which a card attachment/detachment sensor 402 is used to detect attachment/detachment (e.g., the insertion or the removal) of a card 400 according to an embodiment of the present disclosure.

Referring to FIG. 4A, the card attachment/detachment sensor 402 may be a magnetic sensor including a magnet 404 and a lead switch 406. The magnet 404 and the lead switch 406 may be installed such that the card 400 is inserted between the magnet 404 and the lead switch 406 when being received in a card receiving portion. The card attachment/detachment sensor 402 may correspond to the card attachment/detachment sensor 108 illustrated in FIG. 1.

In response to the card 400 being attached to (e.g., inserted into) the card receiving portion, a magnetic force of the magnet 404 may be blocked by the card 400 such that the lead switch 406 is switched off In contrast, in response to the card 400 being detached (e.g., removed) from the card receiving portion, the lead switch 406 may be switched on by the magnetic force of the magnet 404. Thus, attachment/detachment (e.g., the insertion or the removal) of the card 400 may be detected according to the on-state or off-state of the lead switch 406.

Various types of sensors as well as a magnetic sensor such as the card attachment/detachment sensor 402 may be used if the sensors detect card attachment/detachment (e.g., insertion or removal).

FIG. 4B illustrates an example in which an IC card reader 412 is used to detect attachment/detachment (e.g., the insertion or removal) of an IC card 410 if the IC card 410 is used according to an embodiment of the present disclosure.

Referring to FIG. 4B, the IC card 410 may include an IC 414. The IC card reader 412 may be installed to read the IC 414 when the IC card 410 is received in the card receiving portion.

In response to the IC card 410 being attached to (or received in) the card receiving portion, the IC card reader 412 may read the IC 414. In contrast, in response to the IC card 410 being detached (e.g., removed) from the card receiving portion, the IC card reader 412 may not read the IC 414. Thus, according to whether the IC card reader 412 may read the IC 414 or not, attachment/detachment (e.g., the insertion or the removal) of the IC card 410 may be detected. The IC card reader 412 may transmit data obtained by reading the IC 414 to the electronic device 102 through wired communication or wireless communication such as NFC or BT.

FIG. 4C illustrates an example in which if a magnetic card 420 is used, a card attachment/detachment sensor 424 is used to detect attachment/detachment (e.g., the insertion or the removal) of the magnetic card 420 and a magnetic card reader 430 is used to read the magnetic card 420 according to an embodiment of the present disclosure.

Referring to FIG. 4C, the card attachment/detachment sensor 424 may be a magnetic sensor including a magnet 426 and a lead switch 428, similar to the card attachment/detachment sensor 402 of FIG. 4A. The magnet 426 and the lead switch 428 may be installed such that when the card is received in (e.g., inserted into) the card receiving portion, the magnetic card 420 is inserted between the magnet 426 and the lead switch 428.

Once the magnetic card 420 is attached to the card receiving portion, a magnetic force of the magnet 426 may be blocked such that the lead switch 428 is switched off. Once the magnetic card 420 is detached from the card receiving portion, the lead switch 428 may be switched on by the magnetic force of the magnet 426. Thus, attachment/detachment of the magnetic card 420 may be detected according to the on-state or off-state of the lead switch 428.

The magnetic card 420 may include a magnetic stripe 422. A magnetic card reader 430 may be installed to read the magnetic stripe 422 during attachment/detachment (e.g., the insertion or the removal) of the magnetic card 420 to/from the card receiving portion. The magnetic card reader 430 may transmit data obtained by reading the magnetic stripe 422 to the electronic device 102 through wired communication or wireless communication such as NFC or BT.

A cover including multiple card receiving portions may be used for the electronic device 102. Different cards may be received in the multiple card receiving portions. In this case, the card attachment/detachment sensor 108 may also be installed in each of the multiple card receiving portions to detect attachment/detachment (e.g., the insertion or the removal) of a card to/from each card receiving portion. According to various embodiments of the present disclosure, the electronic device 102 may identify a card attached/detached among multiple cards received in the cover. The electronic device 102 may display a UI screen related to the use of the identified card.

According to various embodiments of the present disclosure, the electronic device 102 may identify an attached/detached card based on a position at which the card is attached. The electronic device 102 may identify a position at which the card is attached based on a card attachment/detachment sensor installed in each of the multiple card receiving portions. The user may register information about a card received in each of the multiple card receiving portions in the electronic device 102.

According to various embodiments of the present disclosure, the electronic device 102 may identify an attached/detached (e.g., inserted or removed) card based on data read by the IC card reader 412 illustrated in FIG. 4B. According to various embodiments of the present disclosure, the electronic device 102 may identify an attached/detached card based on the data read by the magnetic card reader 430 of FIG. 4C.

An electronic device according to various embodiments of the present disclosure includes a display configured to display a UI screen related to use of a card and a controller configured to display a UI screen related to use of the card through the display upon detecting detachment of the card from a cover of the electronic device.

The controller identifies the detached card among at least one cards attached to the cover based on a position at which the detached card has been attached to the cover and displays a UI screen related to use of the identified card.

The UI screen includes at least one of a UI screen of a message application, a UI screen of a coupon list application, a UI screen of a membership card list application, and a UI screen of an application list application related to the use of the card.

The controller collects user context information related to the use of the card and determines a UI screen to be displayed based on user context information that has been collected prior to current detachment of the card.

The user context information includes a name of an application running in a state in which the card has been detached (or removed) previously and a UI name of the application, and the controller determines as the UI screen to be displayed, a UI screen of one of an application running most recently and an application running most frequently in the state in which the card has been previously detached (e.g., removed).

The user context information comprises a position of the electronic device when the card is detached, a name of an application running in the state in which the card has been previously detached (e.g., removed), and a UI name of the application, and the controller determines as the UI screen to be displayed, a UI screen of one of an application running most recently and an application running most frequently in the state in which the card has been previously detached (e.g., removed) at the position corresponding to the current position.

The user context information includes a time at which the card is detached (e.g., removed), a time at which the card is attached (e.g., inserted), a position of the electronic device when the card is detached, a name of an application running in the state in which the card has been previously detached (e.g., removed) and a UI name of the application, and the controller determines as the UI screen to be displayed, a UI screen of one of an application running most recently and an application running most frequently in the state in which the card has been previously detached (e.g., removed) in at least one of a position corresponding to the current position and a previous time corresponding to the current time.

The controller returns to an operation state preceding the detachment (e.g., the removal) of the card upon detecting attachment (e.g., the insertion) of the card to the cover after the detachment of the card.

The controller detects attachment (e.g., insertion) and detachment (e.g., removal) of the card to and from the cover through a NFC module.

Through a card attachment and detachment sensor installed in each of at least one card receiving portions included in the cover, the controller detects attachment and detachment of the card to and from the card receiving portion.

The card attachment and detachment sensor includes at least one of an IC card reader and a magnetic sensor.

FIG. 5 is a flowchart illustrating operations of an electronic device according to various embodiments of the present disclosure.

Referring to FIG. 5, the operations in the illustrated flowchart may be performed by, for example, a controller of the electronic device 102.

At operation 500, the electronic device 102 may determine whether a card is detached (e.g., removed) from a cover at operation 500.

At operation 502, the electronic device 102 may start collecting user context information related to the use of the card, upon detecting that the card is detached (e.g., removed) from the cover.

The user context information may include at least one of a time at which the card is detached (e.g., removed), a time at which the detached card is attached (e.g., inserted) to the cover, a position of the electronic device 102 when the card is detached (e.g., removed), a name of an application running when the card is detached (e.g., removed), and a UI name of the application. If multiple cards are received (e.g., inserted) in the cover, the user context information may further include card information regarding each card. The electronic device 102 may store the collected user context information in the memory 130.

At operation 504, the electronic device 102 may display a UI screen related to the use of the detached card on the display 150. The UI screen related to the use of the card may include at least one of respective UI screens of a message application, a coupon list application, a membership card list application, and an application list application related to the use of the card. The message application may be an application that provides a message service such as an SMS or an MMS. The coupon list application may be an application showing a list of coupons that provide discounts for the use of the card. The membership card list application may be an application showing a list of membership cards that provide discounts or mileage points for the use of the card. The application list application related to the use of the card may be an application showing a list of applications related to the use of the card. For example, the application related to the use of the card may be an application used for credit card payment or inquiry, an application available per credit card issuing company or per card, or the like.

According to various embodiments of the present disclosure, the user may register coupons, membership cards, and applications related to the use of the card in a coupon list, a membership card list, and an application list. According to various embodiments of the present disclosure, the coupons, the membership cards, and the applications related to the use of the card may be automatically registered when the electronic device 102 downloads an application or content including an identifier indicating that the use of the card is related through the network 162. For example, the identifier may be a property defined on an application basis.

According to various embodiments of the present disclosure, the electronic device 102 may selectively determine a UI screen to be displayed based on the user context information collected prior to current card detachment at operation 504.

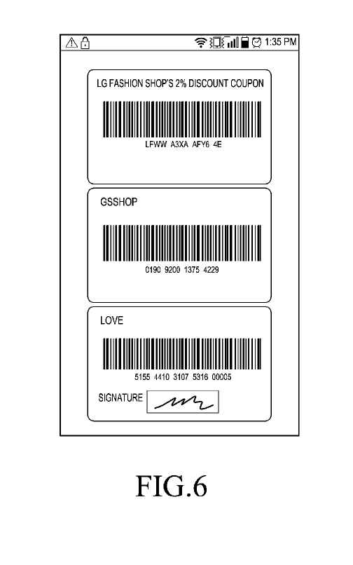

According to various embodiments of the present disclosure, the electronic device 102 may determine based on the user context information, as a UI screen to be displayed, a UI screen of a most recently running application among applications used in the state in which the card has been previously detached (e.g., removed). For example, if the UI screen of the coupon list application is determined as the UI screen of the most recently running application, the electronic device 102 may determine the UI screen of the coupon list application as the UI screen to be displayed at operation 504 and displays the UI screen as illustrated in FIG. 6.

FIG. 6 is a diagram illustrating a UI screen according to various embodiments of the present disclosure.

Referring to FIG. 6, if the user, while not using the electronic device 102, pulls out the card from the cover to use the card, the UI screen related to the use of the card may be automatically displayed. Thus, the user does not need to manipulate the electronic device 102 by turning on and unlocking the screen and then running an application necessary for the use of the card to display a UI screen necessary for the use of the card. When the user, while using the electronic device 102, pulls out the card from the cover, the user does not need to manipulate the electronic device 102 by running an application necessary for the use of the card to display a UI screen necessary for the use of the card.

According to various embodiments of the present disclosure, the electronic device 102 may determine based on the user context information, as a UI screen to be displayed, a UI screen of an application preferred by the user among applications used in the state in which the card has been previously detached (e.g., removed). According to various embodiments of the present disclosure, the electronic device 102 may determine, as the UI screen of the user-preferred application, a UI screen of an application that runs most frequently among the applications used in the state in which the card has been previously detached (e.g., removed).

The electronic device 102 may determine that the detached card is attached (e.g., inserted) to the cover again at operation 506.

At operation 508, the electronic device 102 may terminate collecting the user context information related to the use of the card, upon detecting that the detached card is attached to the cover.

The electronic device 102 may terminate a running application and return to an operation state preceding card detachment at operation 510. For example, if the electronic device 102 has not been used prior to card detachment (e.g., removal), the electronic device 102 may turn off the screen. In another example, if the electronic device 102 has been used prior to card detachment (e.g., removal), the electronic device 102 may display a screen preceding card detachment (e.g., removal).

According to various embodiments of the present disclosure, at operation 504, the electronic device 102 may display a designated UI screen irrespective of the user context information. For example, the electronic device 102 may display a UI screen of the application list application related to the use of the card. The application list related to the use of the card is a list of applications and thus may be irrelevant to the user context information. According to various embodiments of the present disclosure in which the designated UI screen is displayed, an operation of collecting the user context information at the electronic device 102 may be skipped.

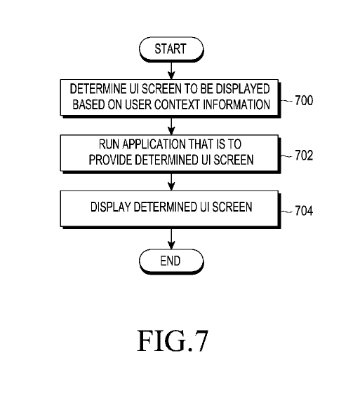

FIG. 7 is a flowchart illustrating operations of displaying a UI screen by an electronic device according to various embodiments of the present disclosure.

Referring to FIG. 7, the operations of the illustrated flowchart may be performed at operation 504 of FIG. 5 by the controller of the electronic device 102.

At operation 700, the electronic device 102 may determine a UI screen to be displayed and an application that is to provide the UI screen to be displayed, based on the user context information.

At operation 702, the electronic device 102 may run the application that is to provide the determined UI screen.

At operation 704, the electronic device 102 may display the UI screen determined at operation 700 among UI screens of the application on the display 150.

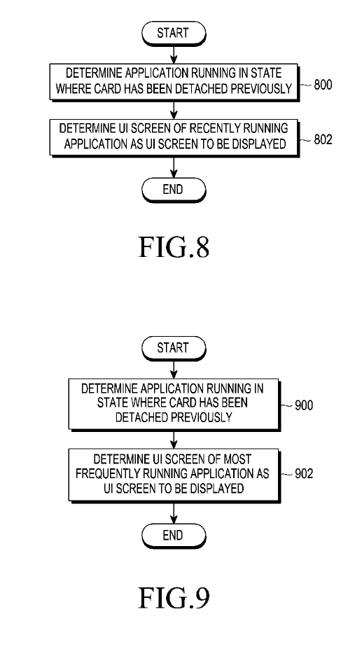

FIGS. 8 to 13 are flowcharts illustrating operations of determining a UI screen to be displayed by an electronic device according to various embodiments of the present disclosure.

Referring to FIGS. 8 to 13, the operations of the illustrated flowcharts may be performed at operation 700 of FIG. 7 by the controller of the electronic device 102.

Referring to FIG. 8, at operation 800, the electronic device 102 may determine based on the user context information, an application running in a state in which the card has been previously detached (e.g., removed).

At operation 802, the electronic device 102 may determine, as a UI screen to be displayed, a UI screen of the most recently running application among applications running in the state in which the card has been previously detached (e.g., removed).

Referring to FIG. 9, at operation 900, the electronic device 102 may determine based on the user context information, an application running in a state in which the card has been previously detached (e.g., removed).

At operation 902, the electronic device 102 may determine as a UI screen to be displayed, a UI screen of the most frequently running application among applications running in the state in which the card has been previously detached (e.g., removed).

If any application does not run in the state in which the card has been previously detached (e.g., removed), information about an application running in the state in which the card has been previously detached (e.g., removed) may not be included in the user context information. In this case, according to various embodiments of the present disclosure, the electronic device 102 may determine a UI screen of a designated application as a UI screen to be displayed, at operation 802 or operation 902.

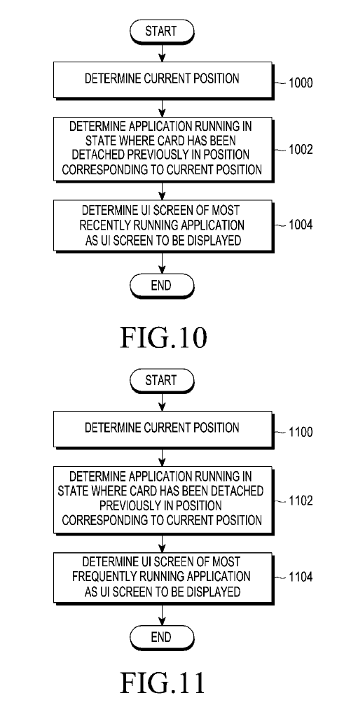

Referring to FIG. 10, at operation 1000, the electronic device 102 may determine a current position thereof.

At operation 1002, the electronic device 102 may determine based on the user context information, an application running in the state in which the card has been previously detached (e.g., removed) in a position corresponding to the current position. According to various embodiments of the present disclosure, the position corresponding to the current position may be the same position as the position at which the card has been detached, or a position falling within a predetermined range from the position at which the card has been detached.

At operation 1004, the electronic device 102 may determine as a UI screen to be displayed, a UI screen of the most recently running application among applications running in the state in which the card has been previously detached (e.g., removed) in the position corresponding to the current position.

Referring to FIG. 11, at operation 1100, the electronic device 102 may determine a current position of the electronic device 102.

At operation 1102, the electronic device 102 may determine based on the user context information, an application running in the state in which the card has been previously detached (e.g., removed) in the position corresponding to the current position.

At operation 1104, the electronic device 102 may determine as a UI screen to be displayed, a UI screen of the most frequently running application among applications running in the state in which the card has been previously detached (e.g., removed) in the position corresponding to the current position.

If any application does not run in the state in which the card has been previously detached (e.g., removed) in the position corresponding to the current position, information about an application running in the state in which the card has been previously detached (e.g., removed) in the position corresponding to the current position may not be included in the user context information. In this case, according to various embodiments of the present disclosure, similar to operation 802 or 902, the electronic device 102 may determine as a UI screen to be displayed, a UI screen of the most recently running application or the most frequently running application irrespective of the current position at operation 1004 or 1104. If any application does not run in the state in which the card has been previously detached (e.g., removed) prior to current card detachment, irrespective of the current position, information about the application running in the state in which the card has been previously detached (e.g., removed) may not be included in the user context information. In this case, according to various embodiments of the present disclosure, the electronic device 102 may determine a UI screen of a designated application as a UI screen to be displayed, at operation 1004 or 1104.

According to various embodiments of the present disclosure, the electronic device 102 may determine the UI screen to be displayed based on the current time, instead of the current position as illustrated in FIGS. 10 and 11.

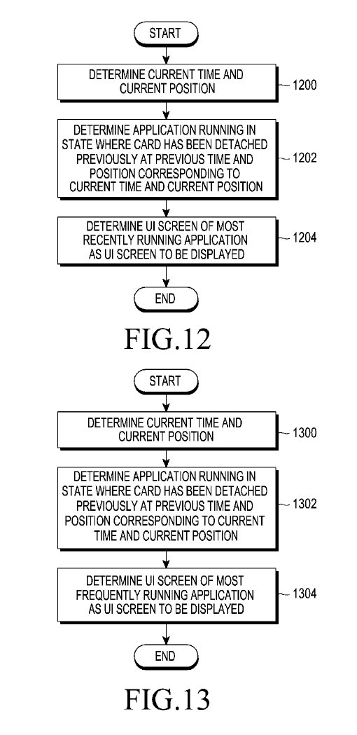

Referring to FIG. 12, at operation 1200, the electronic device 102 may determine a current time and a current position of the electronic device 102.

At operation 1202, the electronic device 102 may determine based on the user context information, an application running in the state in which the card has been previously detached (e.g., removed) at a previous time and a position corresponding to the current time and the current position. According to various embodiments of the present disclosure, the time corresponding to the current time may be the same time as the time at which the card has been detached (e.g., removed) or a time falling within a predetermined range from the time at which the card has been detached (e.g., removed). The position corresponding to the current position may be as described above.

At operation 1204, electronic device 102 may determine as a UI screen to be displayed, a UI screen of the most recently running application among applications running in the state in which the card has been previously detached (e.g., removed) at the previous time and the position corresponding to the current time and the current position.

Referring to FIG. 13, at operation 1300, the electronic device 102 may determine the current time and the current position of the electronic device 102.

At operation 1302, the electronic device 102 may determine based on the user context information, an application running in the state in which the card has been previously detached (e.g., removed) at the previous time and the position corresponding to the current time and the current position.

At operation 1304, the electronic device 102 may determine as a UI screen to be displayed, a UI screen of the most frequently running application among applications running in the state in which the card has been previously detached (e.g., removed) at the previous time and the position corresponding to the current time and the current position.

If any application does not run in the state in which the card has been previously detached (e.g., removed) at the previous time and the position corresponding to the current time and the current position, information about an application running in the state in which the card has been previously detached (e.g., removed) at the time and the position corresponding to the current time and the current position may not be included in the user context information. In this case, according to various embodiments of the present disclosure, the electronic device 102 may determine as a UI screen to be displayed, a UI screen of the most recently running application or the most frequently running application, irrespective of the current time and the current position at operation 1204 or 1304, similar to operation 802 or 902. If any application does not run in the state in which the card has been previously detached (e.g., removed) prior to current card detachment, irrespective of the current time and the current position, then information about the application running in the state in which the card has been previously detached (e.g., removed) may not be included in the user context information. In this case, according to various embodiments of the present disclosure, the electronic device 102 may determine a UI screen of a designated application as a UI screen to be displayed at operation 1204 or 1304.

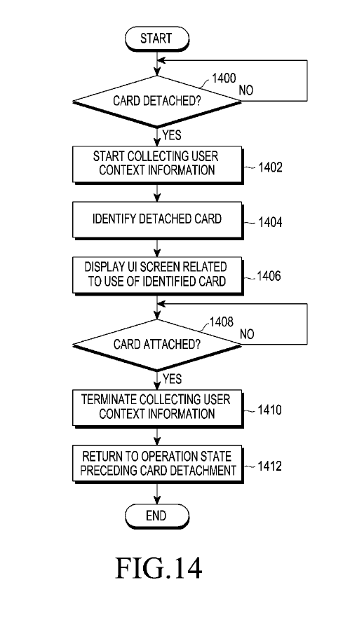

FIG. 14 is a flowchart illustrating operations of an electronic device according to various embodiments of the present disclosure.

Referring to FIG. 14, operations of the illustrated flowchart may be performed by a controller of the electronic device 102.

Referring to FIG. 14, operations 1400, 1402, 1408 through 1412 may correspond to operations 500 through 510 of FIG. 5, and thus will not be repetitively described.

At operation 1400, electronic device 102 may determine whether a card is detached from a cover.

In response to detecting that the card is detached (e.g., removed) from the cover, the electronic device 102 may start collecting user context information related to the use of the card at operation 1402.

At operation 1404, the electronic device 102 may identify the detached card as described above.

At operation 1406, the electronic device 102 may display a UI screen related to the use of the identified card.

At operation 1408, the electronic device 102 may determine whether the detached card is attached (e.g., inserted) to the cover again.

In response to detecting that the detached card is attached (e.g., inserted) to the cover again, the electronic device 102 may terminate collecting the user context information related to the use of the card at operation 1410.

At operation 1412, electronic device 102 may terminate the running application and may return to the operation state preceding card detachment (e.g., removal).

According to various embodiments of the present disclosure relating to FIG. 14, the electronic device 102 may collect the user context information to correspond to the detached card and may display a UI screen related to the use of the detached and identified card based on the user context information.

The electronic device 102 may be selectively set to determine the UI screen according to one of the aforementioned embodiments for determining the UI screen to be displayed.

According to various embodiments of the present disclosure, if the IC card reader 412 of FIG. 4B or the magnetic card reader 430 of FIG. 4C is installed in the card receiving portion of the cover, the electronic device 102 may input card information for payment to an application by using data read by the IC card reader 412 or the magnetic card reader 430.

According to various embodiments of the present disclosure, an electronic device automatically displays a UI screen related to the use of a card if the card is detached (e.g., removed) from a cover of the electronic device to assist user's use of the card, thereby offering the user convenience of having no need to separately manipulate the electronic device for use of the UI screen.

Moreover, according to various embodiments of the present disclosure, if the card is detached (e.g., removed) from the cover, the electronic device selectively determines and displays a UI screen of a user-preferred application among applications related to the use of the detached card based on user context information related to the use of the card, thereby improving the utilization of the electronic device.

Furthermore, according to various embodiments of the present disclosure, if the card is detached (e.g., removed) from the cover, the electronic device selectively determines and displays a UI screen of an application corresponding to at least one of a time and a position at which the card is used among applications related to the use of the detached card based on the user context information related to the use of the card, thereby enhancing the utilization of the electronic device.

According to various embodiments of the present disclosure, a method for assisting use of a card in an electronic device includes detecting detachment of the card from a cover of the electronic device and displaying a UI screen related to use of the card.

The method further includes determining a position at which the detached card has been attached (e.g., inserted) to the cover and identifying the detached card among at least one cards attached (e.g., inserted) to the cover based on the position at which the detached card has been attached (e.g., inserted), in which the displaying of the UI screen includes displaying a UI screen related to use of the identified card.

The UI screen includes at least one of a UI screen of a message application, a UI screen of a coupon list application, a UI screen of a membership card list application, and a UI screen of an application list application related to the use of the card.

According to various embodiments of the present disclosure, the method further includes collecting user context information related to the use of the card, in which the displaying of the UI screen includes determining a UI screen to be displayed based on user context information that has been collected prior to current detachment of the card.

According to various embodiments of the present disclosure, the user context information includes a name of an application running in a state in which the card is previously detached (e.g., removed) and a UI name of the application, and the determining of the UI screen to be displayed includes determining as the UI screen to be displayed, a UI screen of one of an application running most recently and an application running most frequently in the state in which the card has been previously detached (e.g., removed).

According to various embodiments of the present disclosure, the user context information includes a position of the electronic device when the card is detached (e.g., removed), a name of an application running in the state in which the card has been previously detached (e.g., removed), and a UI name of the application, and the determining of the UI screen to be displayed includes determining a current position of the electronic device and determining as the UI screen to be displayed, a UI screen of one of an application running most recently and an application running most frequently in the state in which the card has been previously detached (e.g., removed) at the position corresponding to the current position.

According to various embodiments of the present disclosure, the user context information includes a time at which the card is detached (e.g., removed), a time at which the card is attached, a position of the electronic device when the card is detached (e.g., removed), a name of an application running in a state in which the card is detached (e.g., removed) and a UI name of the application, and the determining of the UI screen to be displayed includes determining a current time and a current position of the electronic device and determining as the UI screen to be displayed, a UI screen of one of an application running most recently and an application running most frequently in the state in which the card has been previously detached (e.g., removed) in at least one of a position corresponding to the current position and a previous time corresponding to the current time.

According to various embodiments of the present disclosure, the method further includes detecting attachment of the card to the cover after the detachment (e.g., the removal) of the card and returning to an operation state preceding the detachment (e.g., the removal) of the card.

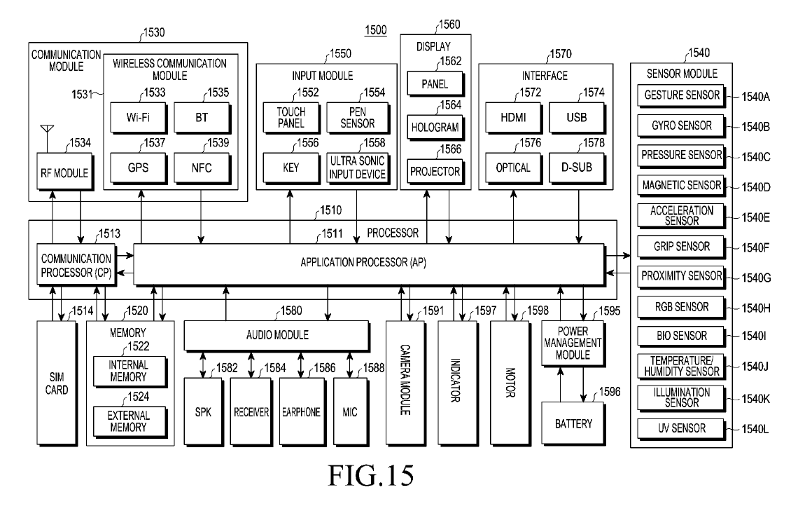

FIG. 15 is a block diagram illustrating an electronic device according to various embodiments of the present disclosure.

Referring to FIG. 15, an electronic device 1500 may form the entire electronic device 102 illustrated in FIG. 1 or a part thereof.

As illustrated in FIG. 15, the electronic device 1500 may include one or more processors 1510, a Subscriber Identification Module (SIM) card 1514, a memory 1520, a communication module 1530, a sensor module 1540, an input module 1550, a display 1560, an interface 1570, an audio module 1580, a camera module 1591, a power management module 1595, a battery 1596, an indicator 1597, and a motor 1598.

The processor 1510 may include one or more Application Processors (APs) 1511 or one or more Communication Processors (CPs) 1513. The processor 1510 may be, for example, the processor 120 illustrated in FIG. 1. Although the APs 1511 and the CPs 1513 are illustrated as being incorporated in the processor 1510 in FIG. 15, they may be included in different IC packages. According to various embodiments of the present disclosure, the APs 1511 and the CPs 1513 may also be included in one IC package.

The AP 1511 may drive an Operating System (OS) or an application program to control multiple hardware or software elements connected to the AP 1511 and to perform processing and operations of various data including multimedia data. The AP 1511 may be implemented with, for example, a System on Chip (SoC). According to various embodiments of the present disclosure, the AP 1511 may further include a Graphic Processing Unit (GPU) (not illustrated).

The CP 1513 may manage a data link and converts a communication protocol in communication between the electronic device 1500 and one or more other electronic devices connected to the electronic device 1500 over a network. The CP 1513 may be implemented with, for example, a SoC. According to various embodiments of the present disclosure, the CP 1513 may perform at least a part of a multimedia control function. The CP 1513 may identify and authenticate the electronic device 1500 in a communication network by using, for example, an SIM (e.g., the SIM card 1514). The CP 1513 may provide services such as voice communication, video communication, a text message, packet data, and the like to the user.

The CP 1513 may control data transmission/reception of the communication module 1530. Although elements such as the CP 1513, the power management module 1595, and the memory 1520 are illustrated as being separated from the AP 1511 in FIG. 15, the AP 1511 may be implemented to include at least some (e.g., the CP 1513) of the foregoing elements.

According to an embodiment, the AP 1511 or the CP 1513 may load a command or data received from at least one of a non-volatile memory connected thereto and other elements to a volatile memory and processes the received command or data. The AP 1511 or the CP 1513 may store data received from at least one of other elements or data generated by at least one of other elements in the nonvolatile memory.

The SIM card 1514 may be a card including an SIM, and may be inserted into a slot formed in a particular position of the electronic device 1500. The SIM card 1514 may include unique identification information (e.g., an Integrated Circuit Card Identifier (ICCID)) or subscriber information (e.g., an International Mobile Subscriber Identity (IMSI)).

The memory 1520 may include an internal memory 1522 and/or an external memory 1524. The memory 1520 may be the memory 130 illustrated in FIG. 1. The internal memory 1522 may include at least one selected from among a volatile memory (e.g., a Dynamic Random Access Memory (DRAM), a Static RAM (SRAM), a Synchronous Dynamic RAM (SDRAM), or the like) and a nonvolatile memory (e.g., One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a Not And (NAND) flash memory, a Not Or (NOR) flash memory, or the like). According to various embodiments of the present disclosure, the internal memory 1522 may be a Solid State Drive (SSD). The external memory 1524 may further include a flash drive, for example, at least one of a compact flash, Secure Digital (SD), micro-SD, mini-SD, extreme digital (xD), and a memory stick. The external memory 1524 may be functionally connected with the electronic device 1500 through various interfaces.

Although not illustrated, a storage device (or storage medium) such as a hard drive may be further included in the electronic device 1500.

The communication module 1530 may include a wireless communication module 1531 or a Radio Frequency (RF) module 1534. The communication module 1530 may be included in the communication interface 160 illustrated in FIG. 1. The wireless communication module 1531 may include, for example, a WiFi module 1533, a BT module 1535, a GPS module 1537, and an NFC module 1539. For example, the wireless communication module 1531 may provide a wireless communication function by using an RF. Additionally or alternatively, the wireless communication module 1531 may include a network interface (e.g., a Local Area Network (LAN) card) or a modem for connecting the electronic device 1500 to a network (e.g., Internet, an LAN, a Wide Area Network (WAN), a communication network, a cellular network, a satellite network, a Plain Old Telephone Service (POTS), or the like).

The RF module 1534 may process transmission/reception of voice or a data signal. The RF module 1534 may include, although not shown, at least one of a transceiver, a Power Amplification Module (PAM), a frequency filter, and a Low Noise Amplifier (LNA). The RF module 1534 may further include a part for transmitting and receiving electromagnetic waves on a free space in wireless communication, for example, a conductor or a conductive wire.

The sensor module 1540 may include at least one selected from among a gesture sensor 1540A, a gyro sensor 1540B, a pressure sensor 1540C, a magnetic sensor 1540D, an acceleration sensor 1540E, a grip sensor 1540F, a proximity sensor 1540G, a color sensor 1540H (e.g., Red, Green, Blue (RGB) sensor), a bio sensor 1540I, a temperature/humidity sensor 1540J, an illumination sensor 1540K, an Ultra Violet (UV) sensor 1540L, an Infrared (IR) sensor (not illustrated), and/or the like. The sensor module 1540 may measure a physical quantity or detects an operation state of the electronic device 1500 to convert the measured or detected information into an electric signal. Additionally or alternatively, the sensor module 1540 may include at least one selected from among an E-nose sensor (not illustrated), an Electromyography (EMG) sensor (not illustrated), an Electroencephalogram (EEG) sensor (not illustrated), an Electrocardiogram (EGC) sensor (not illustrated), a fingerprint sensor (not illustrated), and the like. The sensor module 1540 may further include a control circuit for controlling at least one sensors included therein.

The input module 1550 may include a touch panel 1552, a (digital) pen sensor 1554, a key 1556, or an ultrasonic input device 1558. The input module 1550 may be included in, for example, the input/output interface 140 illustrated in FIG. 1. The touch panel 1552 may recognize a touch input by using at least one of a capacitive, a resistive, infrared, or ultrasonic scheme. The touch panel 1552 may further include a controller (not illustrated). For the capacitive touch panel 1552, recognition of a physical contact or approach is possible. The touch panel 1552 may further include a tactile layer. In this case, the touch panel 1552 may provide tactile reaction to a user.

The (digital) pen sensor 1554 may be implemented using a method that is the same as or similar to a user's touch input or by using a separate recognition sheet. The key 1556 may include a physical button, an optical key, a keypad, or a touch key. The ultrasonic input device 1558 may use an input tool that generates an ultrasonic signal and enable the electronic device 1500 to determine data by detecting the ultrasonic signal to a microphone (e.g., the microphone 1588), thereby enabling wireless recognition. According to various embodiments of the present disclosure, the electronic device 1500 may receive a user input from an external electronic device (e.g., a network, a computer, or a server) connected thereto by using the communication module 1530.

The display 1560 may include a panel 1562, a hologram device 1564, or a projector 1566. The display 1560 may be, for example, the display 150 illustrated in FIG. 1. The panel 1562 may be, for example, a Liquid Crystal Display (LCD), an Active-Matrix Organic Light-Emitting Diode (AMOLED), or the like. The panel 1562 may be implemented as being flexible, transparent, or wearable. The panel 1562 may be implemented with the touch panel 1552 as one module. The hologram device 1564 may show a stereoscopic image in the air by using interference of light. The projector 1566 may project light onto the screen to display an image. According to various embodiments of the present disclosure, the display 1560 may further include a control circuit for controlling the panel 1562, the hologram device 1564, or the projector 1566.

The interface 1570 may include a HDMI 1572, a USB 1574, an optical interface (OPTICAL) 1576, or a D-subminiature (D-SUB) 1578. The interface 1570 may be included in the communication interface 160 illustrated in FIG. 1. Additionally or alternatively, the interface 1570 may include a Mobile High-definition Link (MHL) interface, an SD card/Multimedia Card (MMC) interface, an infrared Data association (IrDA) standard interface, and/or the like.

The audio module 1580 may bi-directionally convert sound and an electric signal. The audio module 1580 may be included in, for example, the input/output interface 140 illustrated in FIG. 1. The audio module 1580 may process sound information input or output through at least one of the speaker (SPK) 1582, a receiver 1584, an earphone 1586, and the microphone (MIC) 1588.

The camera module 1591 may be a device capable of capturing still and moving images, and according to an embodiment, may include one or more image sensors (e.g., a front sensor or a rear sensor), a lens (not illustrated), an Image Signal Processor (ISP, not illustrated), or a flash (not illustrated, for example, a Light Emitting Diode (LED) or a xenon lamp).

The power management module 1595 manages power of the electronic device 1500. Although not shown, a Power Management Integrated Circuit (PMIC), a charger IC, or a battery or fuel gauge may be included in the power management module 1595.

The PMIC may be mounted in, for example, an IC or a SoC semiconductor. The charging method may be classified into a wired type and a wireless type. The charger IC may charge a battery, and may prevent introduction of an over-voltage or over-current from a charger. According to various embodiments of the present disclosure, the charger IC may include a charger IC for at least one of a wired charging method and a wireless charging method. The wireless charging method may include, for example, a magnetic resonance method, a magnetic induction method, or an electromagnetic wave method, and an additional circuit for wireless charging, for example, a coil loop, a resonance circuit, or a rectifier may be added for the wireless charging method.

The battery gauge may measure the remaining capacity of the battery 1596, and a voltage, a current, or a temperature of the battery 1596 during charging. The battery 1596 may store or produce electricity and supplies power to the electronic device 1500 by using the stored or produced electricity. The battery 1596 may include a rechargeable battery or a solar battery.

The indicator 1597 may display a particular state, for example, at least one of a booting state, a message state, and a charging state, of the electronic device 1500 or a part thereof (e.g., the AP 1511). The motor 1598 may convert an electric signal into mechanical vibration.

Although not illustrated, a processor (e.g., a GPU) for supporting a mobile TV may be included in the electronic device 1500. The processor for supporting a mobile TV may process, for example, media data following standards such as Digital Multimedia Broadcasting (DMB), Digital Video Broadcasting (DVB), a media flow, or the like.

The foregoing elements of the electronic device according to various embodiments of the present disclosure may include one or more components, and a name of an element may vary according to a type of the electronic device. The electronic device according to various embodiments of the present disclosure may include at least one of the foregoing elements, and some of them may be omitted from the electronic device or other elements may be further included in the electronic device. In addition, some of the elements of the electronic device according to various embodiments of the present disclosure may be combined into one entity to perform the same function as those of the elements that have not been combined.

The term “module” used in various embodiments of the present disclosure may mean a unit including a combination of one or more of hardware, software, and firmware. The “module” may be interchangeably used with a term such as a unit, logic, a logical block, a component, or a circuit. The “module” may be a minimum unit of parts formed integrally as one piece or a part thereof The “module” may be a minimum unit that performs one or more functions or a part of the minimum unit. The “module” may be mechanically or electronically implemented. For example, the “module” according to various embodiments of the present disclosure may include at least one of an Application-Specific Integrated Circuit (ASIC) chip, Field-Programmable Gate Arrays (FPGAs), and a programmable-logic device that are well-known or to be developed, which perform certain operations.

According to various embodiments, at least a part of a device (e.g., modules or functions thereof) or a method (e.g., operations) according to various embodiments of the present disclosure may be implemented with a command stored in, for example, a non-transitory computer-readable storage medium in the form of a programming module. When the command is executed by one or more processors (e.g., the processor 120), the one or more processors may perform a function corresponding to the command. The non-transitory computer-readable storage medium may be, for example, the memory 130. At least a part of the programming module may be implemented (e.g., executed) by the processor 120. At least a part of the programming module may include at least one of a module, a program, a routine, sets of instructions, and a process to perform one or more functions.

The non-transitory computer-readable storage medium may include magnetic media such as a hard disk, a floppy disk, and a magnetic tape optical media such as a Compact Disc Read Only Memory (CD-ROM) and a DVD, magneto-optical media such as a floptical disk, and a hardware device specially configured to store and execute a program command (e.g., a programing module) such as a ROM, a RAM, and a flash memory. The program command may include not only a mechanical language code generated by a compiler, but also a high-level language code that may be executed by a computer using an interpreter. The hardware device may be configured to operate as one or more software modules for performing operations according to various embodiments of the present disclosure or vice versa.

According to various embodiments of the present disclosure, in a non-transitory computer-readable recording medium having recorded thereon a program to be executed on a computer, the program may include executable instructions that, when executed by a processor, cause the processor to perform operations of detecting detachment of the card from a cover of the electronic device and displaying a UI screen related to use of the card.

An electronic device according to various embodiments of the present disclosure may receive and store a program including instructions for instructing the electronic device to perform a method for assisting use of the card from a program providing apparatus connected to the electronic device in a wired or wireless manner, and the electronic device illustrated in FIG. 1 or a server may be a program providing apparatus. The program providing apparatus may include a memory for storing the program, a communication module for performing wired or wireless communication with the electronic device, and a processor for transmitting the program to the electronic device at the request or automatically.

A module or programming module according to various embodiments of the present disclosure may include at least one of the foregoing components, or some of the foregoing components may be omitted or other components may be further included. Operations executed by a module, a programming module, or other components according to various embodiments of the present disclosure may be performed sequentially, in parallel, repetitively, or heuristically. Some operations may be executed in another order or may be omitted, or other operations may be added.

Other effects that may be obtained or expected from the various embodiments of the present disclosure are explicitly or implicitly disclosed in the detailed description of the embodiment of the present disclosure. For example, various effects expected from the embodiments of the present disclosure have been disclosed in the detailed description of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for assisting use of a card in an electronic device, the method comprising:
detecting detachment of the card from a cover operatively connected to the electronic device; and
in response to detecting the detachment of the card, displaying a User Interface (UI) screen related to use of the card.

2. The method of claim 1, further comprising:
determining a position at which the detached card has been attached to the cover; and
identifying the detached card among one or more cards attached to the cover based on the position at which the detached card has been attached,
wherein the displaying of the UI screen comprises displaying a UI screen related to use of the identified card.

3. The method of claim 1, wherein the UI screen comprises at least one of a UI screen of a message application, a UI screen of a coupon list application, a UI screen of a membership card list application, and a UI screen of an application list application related to the use of the card.

4. The method of claim 1, further comprising:
collecting user context information related to the use of the card,
wherein the displaying of the UI screen comprises determining a UI screen to be displayed based on user context information that has been collected prior to current detachment of the card.

5. The method of claim 4, wherein the user context information comprises a name of an application running in a state in which the card has been previously detached and a UI name of the application, and
wherein the determining of the UI screen to be displayed comprises determining, as the UI screen to be displayed, a UI screen of one of an application running most recently and an application running most frequently in the state in which the card has been previously detached.

6. The method of claim 4, wherein the user context information comprises a position of the electronic device when the card is detached, a name of an application running in the state in which the card has been previously detached, and a UI name of the application, and
wherein the determining of the UI screen to be displayed comprises:
determining a current position of the electronic device; and
determining, as the UI screen to be displayed, a UI screen of one of an application running most recently and an application running most frequently in the state in which the card has been previously detached at the position corresponding to the current position.

7. The method of claim 4, wherein the user context information comprises a time at which the card is detached, a time at which the card is attached, a position of the electronic device when the card is detached, a name of an application running in a state in which the card has been previously detached and a UI name of the application, and
wherein the determining of the UI screen to be displayed comprises:
determining a current time and a current position of the electronic device; and
determining as the UI screen to be displayed, a UI screen of one of an application running most recently and an application running most frequently in the state in which the card has been previously detached in at least one of a position corresponding to the current position and a previous time corresponding to the current time.

8. The method of claim 4, wherein the collecting of the user context information related to the use of the card comprises:
determining context information related to operation of the electronic device that is associated with detachment of the card; and
storing the context information.

9. The method of claim 1, further comprising:
detecting attachment of the card to the cover after the detachment of the card; and
in response to detecting the attachment of the card to the cover, returning to an operation state preceding the detachment of the card.

10. An electronic device comprising:
a display configured to display a User Interface (UI) screen related to use of a card; and
a controller configured to:
detect detachment of the card from a cover operatively connected to the electronic device, and
display a UI screen related to use of the card through the display in response to detecting detachment of the card from the cover.

11. The electronic device of claim 10, wherein the controller is further configured to identify the detached card among one or more cards attached to the cover based on a position at which the detached card has been attached to the cover and to display a UI screen related to use of the identified card.

12. The electronic device of claim 10, wherein the UI screen comprises at least one of a UI screen of a message application, a UI screen of a coupon list application, a UI screen of a membership card list application, and a UI screen of an application list application related to the use of the card.

13. The electronic device of claim 10, wherein the controller is further configured to collect user context information related to the use of the card, and to determine a UI screen to be displayed based on user context information that has been collected prior to current detachment of the card.

14. The electronic device of claim 13, wherein the user context information comprises a name of an application running in a state in which the card has been previously detached and a UI name of the application, and
wherein the controller determines as the UI screen to be displayed, a UI screen of one of an application running most recently and an application running most frequently in the state in which the card has been previously detached.

15. The electronic device of claim 13, wherein the user context information comprises a position of the electronic device when the card is detached, a name of an application running in the state in which the card has been detached, and a UI name of the application, and
wherein the controller is further configured to determine as the UI screen to be displayed, a UI screen of one of an application running most recently and an application running most frequently in the state in which the card has been previously detached at the position corresponding to the current position.

16. The electronic device of claim 13, wherein the user context information comprises a time at which the card is detached, a time at which the card is attached, a position of the electronic device when the card is detached, a name of an application running in a state in which the card has been previously detached and a UI name of the application, and
wherein the controller is further configured to determine as the UI screen to be displayed, a UI screen of one of an application running most recently and an application running most frequently in the state in which the card has been previously detached in at least one of a position corresponding to the current position and a previous time corresponding to the current time.

17. The electronic device of claim 10, wherein the controller is further configured to detect an attachment of the card to the cover after the detachment of the card, and to return to an operation state preceding the detachment of the card in response to detecting attachment of the card to the cover.

18. The electronic device of claim 10, wherein the controller is further configured to detect attachment and detachment of the card to and from one or more card receiving portions included in the cover by using a Near Field Communication (NFC) module or a card attachment and detachment sensor installed in each of the one or more card receiving portions included in the cover.

19. The electronic device of claim 18, wherein the card attachment and detachment sensor comprises at least one of an Integrated Circuit (IC) card reader and a magnetic sensor.

20. A non-transitory computer-readable recording medium having recorded thereon a program to be executed on a computer, wherein the program comprises executable instructions that, when executed by a processor, cause the processor to perform operations of:
detecting detachment of the card from a cover operatively connected to the electronic device; and
in response to detecting the detachment of the card, displaying a User Interface (UI) screen related to use of the card.
